(19) United States
(12) Patent Application Publication
(10) Pub. No.: US 2010/0224320 A1
(43) Pub. Date: Sep. 9, 2010

(54) APPARATUS FOR DE-BONDING FLEXIBLE DEVICE AND METHOD FOR DE-BONDING FLEXIBLE DEVICE

(75) Inventors: Pao-Ming Tsai, Kaohsiung City (TW); Liang-You Jiang, Taipei County (TW); Yu-Yang Chang, Hsinchu County (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/488,934

(22) Filed: Jun. 22, 2009

(30) Foreign Application Priority Data
Mar. 9, 2009 (TW) TW098107524

(51) Int. Cl. B32B 38/10; B29C 63/00

(52) U.S. Cl. 156/344; 156/584

(57) ABSTRACT

The invention provides an apparatus for de-bonding a flexible device and method thereof. The apparatus for de-bonding a flexible device includes a carrier to mount a carrier substrate thereon, a release layer thereon and a flexible device covering the release layer. A separation device disposed over the carrier is used to separate the flexible device from the release layer and the carrier substrate with air entering into an interface between the flexible device and the release layer. A vacuum device disposed over the carrier is used to suction the flexible device.

### CROSS REFERENCE TO RELATED APPLICATIONS

This Application claims priority of Taiwan Patent Application No. 098107524, filed on Mar. 9, 2009, the entirety of which is incorporated by reference herein.

### BACKGROUND OF THE INVENTION

1. Field of the Invention

The present invention relates to an apparatus for de-bonding a flexible device and method for de-bonding a flexible device, and in particular, to an apparatus for de-bonding a flexible device disposed on a release layer and method for de-bonding a flexible device disposed on a release layer.

2. Description of the Related Art

Glass displays have disadvantages such as fragility, poor impact resistance, heavy weight and being thick, thereby hindering application in portable electronic products with light weights, and thin and flexible frames. Thus, flexible substrates replacing glass displays have been disclosed, overcoming the disadvantages of glass displays and allowing increased design flexibility for shape and curl resultant of display panels.

Thus, a novel apparatus for de-bonding a flexible device and method for de-bonding a flexible device having high throughput are desired.

### BRIEF SUMMARY OF INVENTION

An apparatus for de-bonding a flexible device and method for de-bonding a flexible device are provided. An exemplary embodiment of apparatus for de-bonding a flexible device comprises a carrier used to mount a carrier substrate thereon, a release layer thereon and a flexible device covering the release layer. A separation device is disposed over the carrier to separate the flexible device from the release layer and the carrier substrate with air entering into an interface between the flexible device and the release layer. A vacuum device is disposed over the carrier to suction the flexible device.

An exemplary embodiment of a method for de-bonding a flexible device, comprising providing a first carrier to mount a carrier substrate thereon, a release layer thereon and a flexible device covering the release layer and a portion of the carrier substrate. A vacuum suction process is performed to suction the flexible device using a vacuum device. A separation process is performed with air entering into an interface between the flexible device and the release layer to separate the flexible device from the release layer and the carrier substrate using a separation device. A first release process is performed so that the separated flexible device is separated from the vacuum device.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram showing one exemplary embodiment of an apparatus for de-bonding a flexible device.

FIGS. 2a to 2e show a method for de-bonding a flexible device of the invention.

FIGS. 3a to 3b show other exemplary embodiments of an apparatuses for de-bonding a flexible device, showing different separation devices.

FIG. 4 shows a de-bonding diagram of one exemplary embodiment of an apparatus for de-bonding a flexible device, showing one exemplary embodiment of an apparatus for de-bonding a flexible device de-bonding the flexible device with various angles.

FIG. 5 is a flow diagram showing a method for de-bonding a flexible device of the invention.

### DETAILED DESCRIPTION OF INVENTION

The following description is of a mode for carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer the same or like parts.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice of the invention.

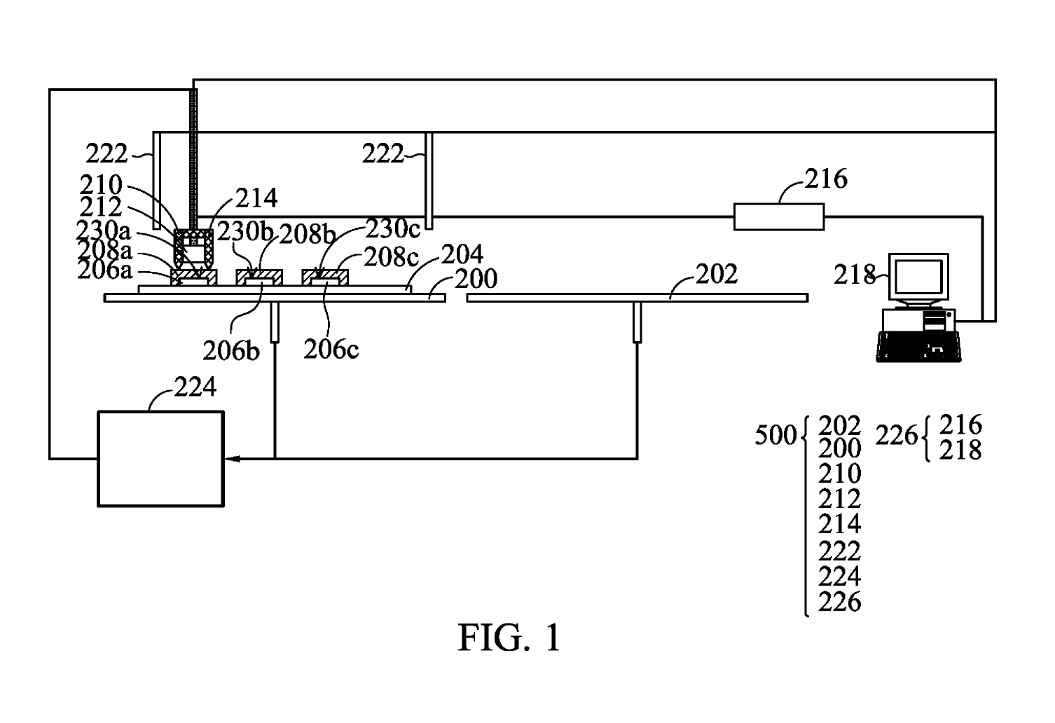

FIG. 1 is a schematic diagram showing one exemplary embodiment of an apparatus 500 for de-bonding a flexible device. The apparatus 500 for de-bonding a flexible device comprises a first carrier 200, a second carrier 202, a separation device 210 and a vacuum device 212. The first carrier 200 is used to mount a carrier substrate 204 thereon and separated flexible devices 208a, 208b and 208c disposed on the carrier substrate 204. It is note that separated release layers 206a, 206b and 206c are respectively between the flexible devices 208a, 208b and 208c and the carrier substrate 204. The release layers 206a, 206b and 206c have a function wherein the flexible devices 208a, 208b and 208c disposed on the carrier substrate 204 may be separated from the carrier substrate 204 when using the method for easily de-bonding the flexible device. In one embodiment, the carrier substrate 204 may comprise a hard substrate such as a glass substrate, a silicon substrate, a quartz substrate or a sapphire substrate. The hard substrate may maintain an original shape without distortion, such as when moved or carried. Also, the hard substrate allows easy performance control of the flexible electronic devices formed thereon. In one embodiment, the release layers 206a, 206b and 206c may comprise parylene. For example, the release layers 206a, 206b and 206c may comprise RICHMOND PRODUCTS INC. release layer A5000, VAC-PAK A6200, E3760, VAC-PAK E4760 or E2760. In one embodiment, the flexible devices 208a, 208b and 208c may comprise a flexible substrate, a flexible gas and hydraulic barrier layer or a flexible electronic device such as a flexible electronic display, a flexible electronic touch panel, a flexible solar cell or a flexible electronic sensor.

Additionally, the first carrier 200 may mount the carrier substrate 204 by vacuum suction, electrostatic suction, adhesive suction or tenon fixing. The second carrier 202 is used to mount the flexible devices separated using the apparatus 500 for de-bonding a flexible device, thereby allowing subsequent processes for fabricating the flexible devices. For example, adhering or bonding the flexible devices to a flexible circuit board. Additionally, the second carrier 202 may mount the separated flexible devices by vacuum suction, electrostatic suction, adhesive suction or tenon fixing. For example, when the first carrier 200 and the second carrier 202 mount the flexible devices by vacuum suction, the first carrier 200 and the second carrier 202 are connected to a vacuum pump 224, respectively.

As shown in FIG. 1, the separation device 210 of the apparatus 500 may be disposed over the first carrier 200 or the second carrier 202. The separation device 210 is used to enable air to enter into the interfaces 230a, 230b or 230c between the release layers 206a, 206b or 206c and the flexible devices 208a, 208b or 208c, thereby allowing the flexible devices 208a, 208b or 208c to be separated from the release layers 206a, 206b or 206c and the carrier substrate 204. In one embodiment, the separation device 210 may comprise a cutting knife. For example, the separation device 210 may be a hollow squared cutting knife 210 or four I-shaped cutting knives 210 as shown in FIG. 1, wherein a hardness of the cutting knife 210 may be larger than that of the flexible devices 208a, 208b and 208c. In one embodiment, a size of the separation device 210 may be changed according to the size of the flexible devices. In one embodiment, the separation device 210 may be connected to a computer 218 to control the operation of the separation device 210.

As shown in FIG. 1, a vacuum device 212 of the apparatus 500 may be disposed over the first carrier 200 and the second carrier 202, connected to the separation device 210. The vacuum device 212 is used to suction the flexible devices 208a, 208b or 208c to prevent the separated flexible devices 208a, 208b or 208c from curving due to process such as cutting. Also, the vacuum device 212 provides stable suction for the separated flexible devices 208a, 208b or 208c so that the separated flexible devices 208a, 208b or 208c can be moved onto the second carrier 202. In one embodiment, the vacuum device 212 may be connected to the separation device 210, for example, the cutting knife 210, through a spring 214. The spring 214 is used to change the vertical distance between the vacuum device 212 and the separation device 210, for example, the cutting knife 210, thereby retarding a downward pressure applied by the cutting knife 210 to the vacuum device 212. Therefore, the spring 214 can prevent the flexible devices 208a, 208b or 208c suctioned by the vacuum device 212 from damage due to the downward pressure applied by the cutting knife 210. In one embodiment, the vacuum device 212 and the vacuum pump 224 may be connected to the computer 218 to control operations such as vacuum suction of the vacuum device 212.

Additionally, as shown in FIG. 1, the apparatus 500 for de-bonding a flexible device may further comprise a moving device 226 connected to the separation device 210 and the vacuum device 212, wherein the moving device 226 is used to change a relative position and a relative height of the separation device 210 and the vacuum device 212 to the first and second carriers 200 and 202. For example, the moving device 226 allows the separation device 210 and the vacuum device 212 to move to a proper position, thereby performing a process of separating or moving the flexible devices. In one embodiment, the moving device 226 may comprise a motor 216 and a control computer 218 connected to the motor 216 to control the operation of the motor 216. In one embodiment, the motor 216 may comprise a stepping motor or a servo motor. The apparatus 500 for de-bonding a flexible device may further comprise a detecting device 222 comprising a charge-coupled device (CCD) to detect a relative position of the flexible devices 208a, 208b or d 208c to the separation device 210 and the vacuum device 212. The detecting device 222 may allow the separation device 210 to align to a specific position of the flexible devices 208a, 208b or 208c (e.g., scribe lines) to perform a separation process. Alternatively, the detecting device 222 may allow the vacuum device 212 to align to a specific position of the flexible devices 208a, 208b or 208c (e.g., the center position of the flexible devices 208a, 208b or 208c) to suction the flexible devices 208a, 208b or 208c, thereby avoiding cutting or sucking position error due to misalignment.

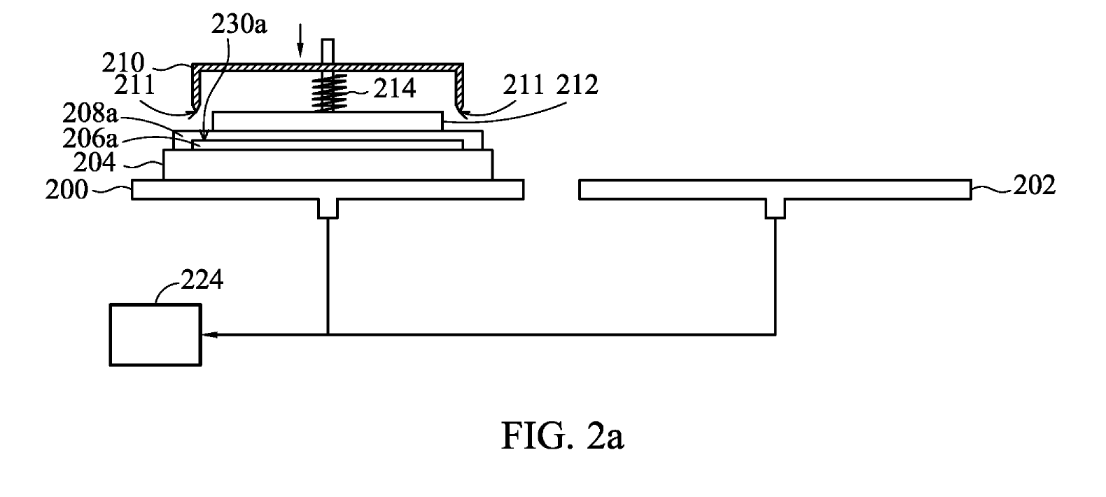

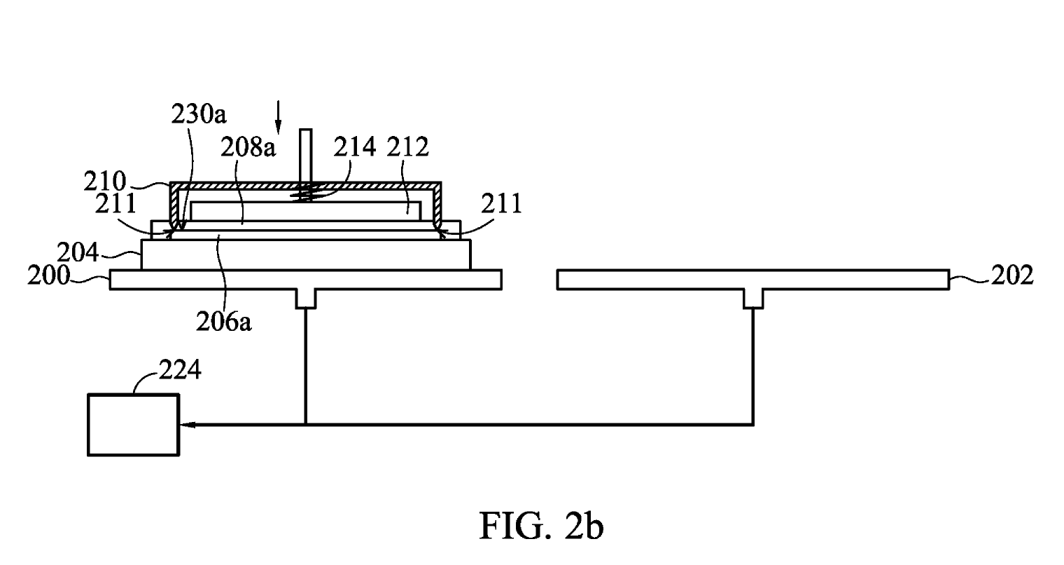

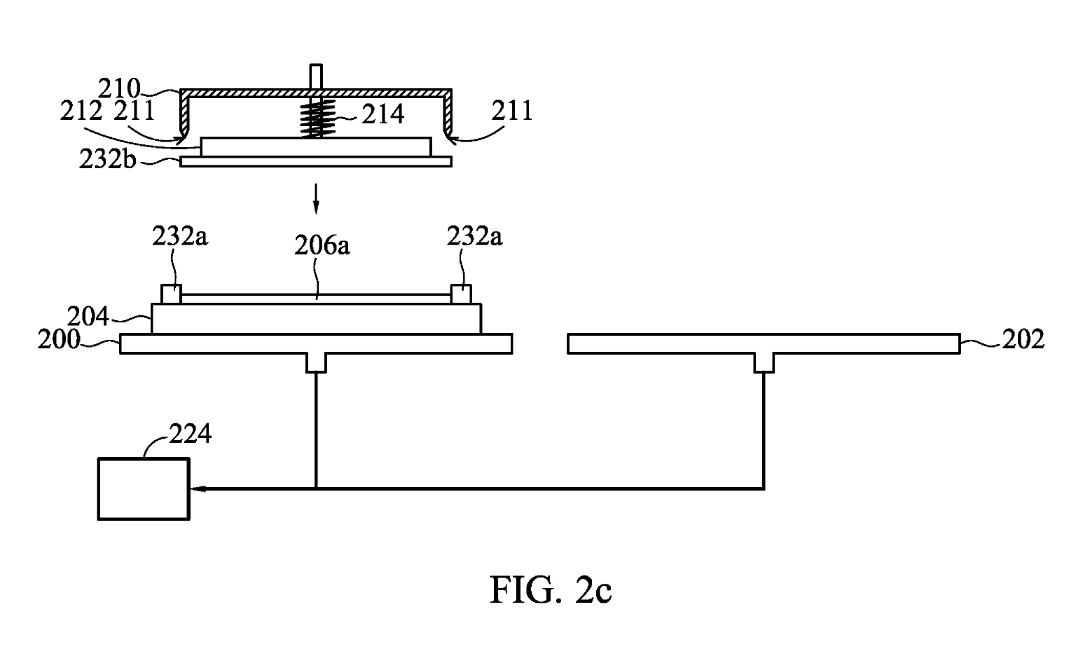

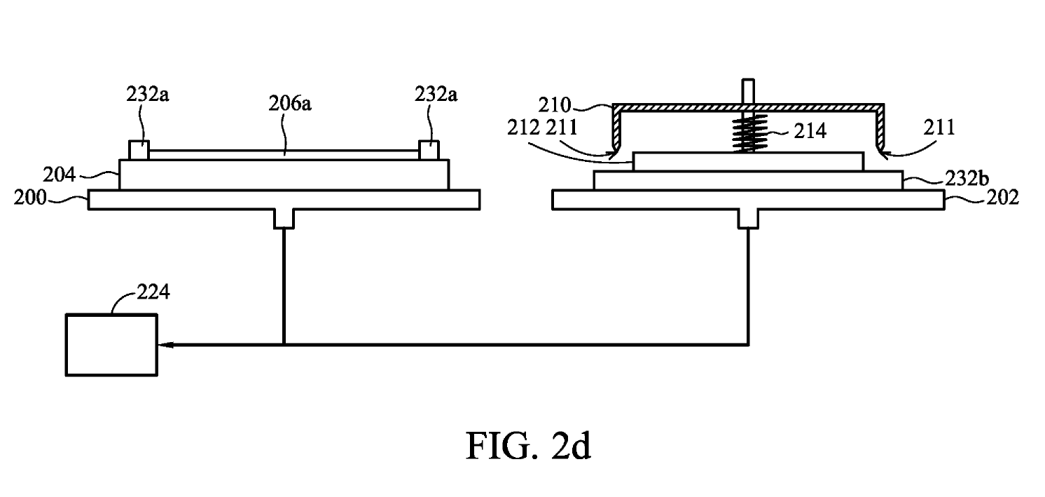

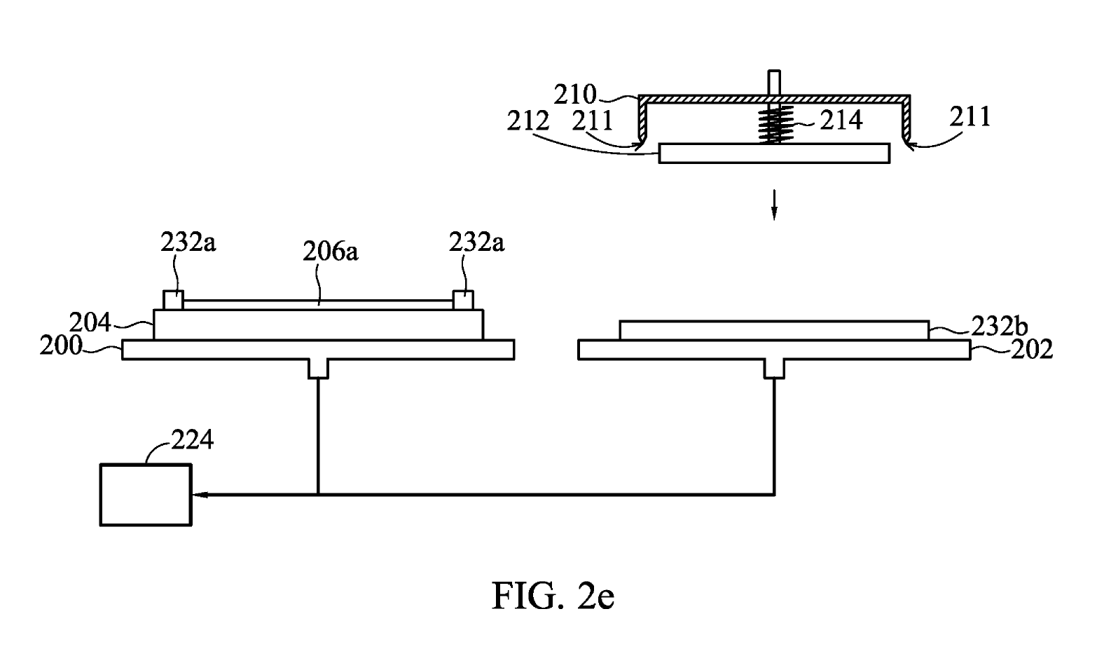

FIGS. 2a to 2e show a method for de-bonding a flexible device 208a of the invention. The figures show the flexible device 208a, the first carrier 200, the second carrier 202 and the vacuum pump 224 connected to the first and second carriers 200 and 202 of the apparatus 500 for de-bonding a flexible device. The computer 218, the detecting device 222, moving device 226 and other device of the apparatus 500 for de-bonding a flexible device as shown in FIG. 1 are not shown herein for brevity. As shown in FIG. 2a, a first carrier 200 and a second carrier 202 are first provided. The first carrier 200 is used to mount a carrier substrate thereon 204, a release layer 206a thereon and a flexible device 208a covering the release layer 206a and a portion of the carrier substrate 204. The second carrier 202 is used to mount the separated flexible devices fabricated in following de-bonding processes.

Next, a vacuum suction process is performed so that the vacuum device 212 and the separation device 210 are moved over the flexible device 208a and aligned to a specific position. The flexible device 208a is then suctioned by the vacuum device 212. The vacuum suction process may be performed by using a computer 218to control a removing device 216 connected to the vacuum device 212 and the separation device 210, and a detecting device 222. For example, as shown in FIG. 2a, the vacuum device 212 is used to suction the center of the flexible device 208a to prevent the separated flexible device from curving due to the cutting process. Also, the vacuum device 212 provides stable suction for the separated flexible device. At this time, a cutting edge 211 of the separation device 210, for example, a cutting knife 210, is disposed directly over an interface 230a between the release layer 206a and the flexible device 208a.

Next, as shown in FIG. 2b, a separation process is performed with air entering into the interface 230a between the release layer 206a and the flexible device 208a using the separation device 210. For example, when the separation device 210 is a cutting knife, the separation device 210, driven by the computer 218, may apply a downward pressure on a specific position according to the interface 230a between the release layer 206a and the flexible device 208a to cut the flexible device 208a. Therefore, air enters into the interface 230a between the release layer 206a and the flexible device 208a, so that the flexible device 208a is separated from the release layer 206a and the carrier substrate 204. Alternatively, a downward pressure may be applied on the flexible device 208a according to the interface 230a between the release layer 206a and the flexible device 208a to cut the flexible device 208a using a stamping method. At this time, the spring 214 disposed between the separation device 210 and the vacuum device 212 may retard a downward pressure applied by the separation device 210 to the vacuum device 212, thereby preventing the flexible device 208c being suctioned by the vacuum device 212 from damage due to the downward pressure applied by the separation device 210.

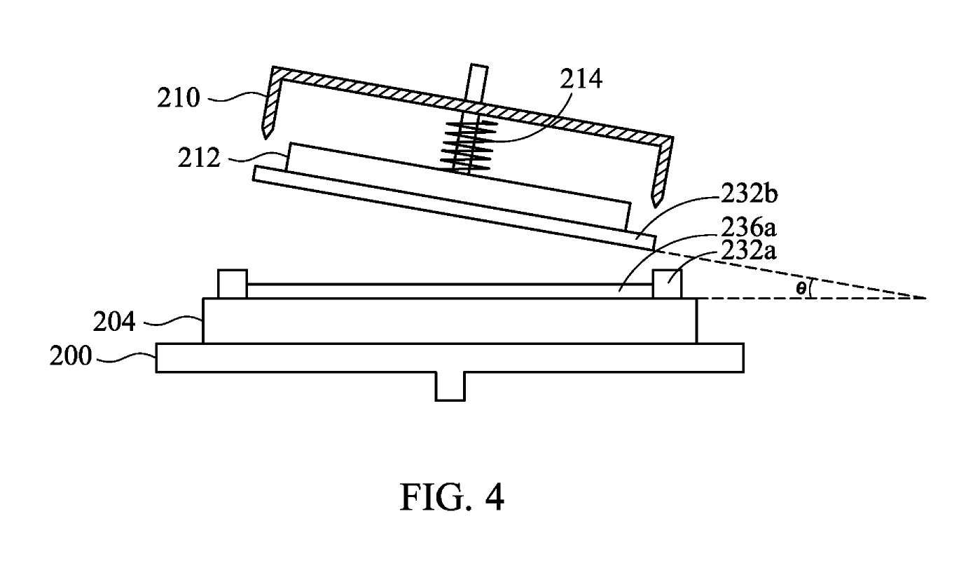

As shown in FIG. 2c, a separated flexible device 232b suctioned by the vacuum device 212 is separated from the carrier substrate 204 after performing the separation process. And a remaining flexible device 232a is attached to the carrier substrate 204. At this time, the vacuum device 212 continuously suctions the separated flexible device 232b, thereby moving the separated flexible device 232b onto the second carrier 202. Additionally, in other embodiment, the vacuum device 212 can be used to separate the flexible device 232b from the carrier substrate 204 at different angles. As shown in FIG. 4, the separated flexible device 232b separated from the carrier substrate 204 is suctioned by the vacuum device 212. An angle θ between a surface of the carrier substrate 204 and a surface of the separated flexible device 232b may be between 0 and 90 degrees.

Next, as shown in FIG. 2d, a removal process is performed to move the separated flexible device 232b suctioned by the vacuum device 212 to the second carrier 202 using a moving device 216, which is driven by the computer 218 as shown in FIG. 1, connected to the separation device 210 and the vacuum device 212.

Next, as shown in FIG. 2e, a first release process such as a vacuum release process is performed so that the separated flexible device 232b is separated from the vacuum device 212. At this time, the second carrier 202 may mount the separated flexible device 232b by vacuum suction, electrostatic suction, adhesive suction or tenon fixing.

Next, a second release process may be performed optionally so that the carrier substrate 204 is separated from the first carrier 200 by a process such as a vacuum release process, an electrostatic release process or a removal process. Therefore, completing the method for de-bonding a flexible device of the invention. The method for de-bonding a flexible device may cut and release the flexible device by vacuum suction at the same time, thereby de-bonding the flexible substrate having a release layer from the carrier.

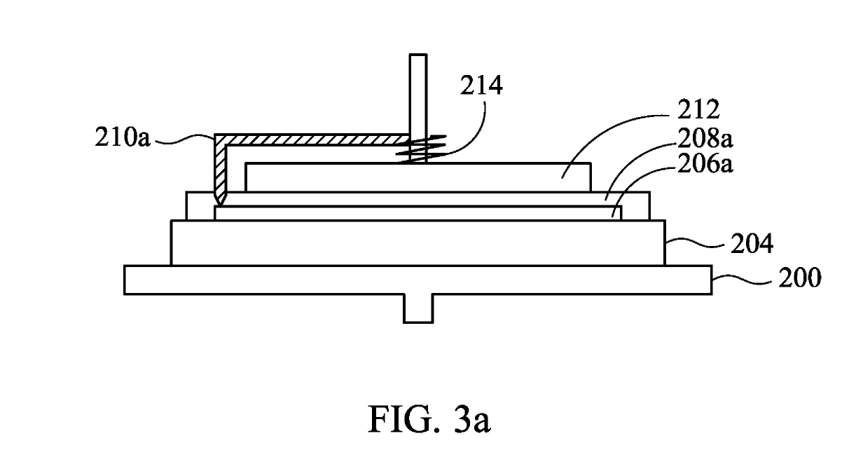

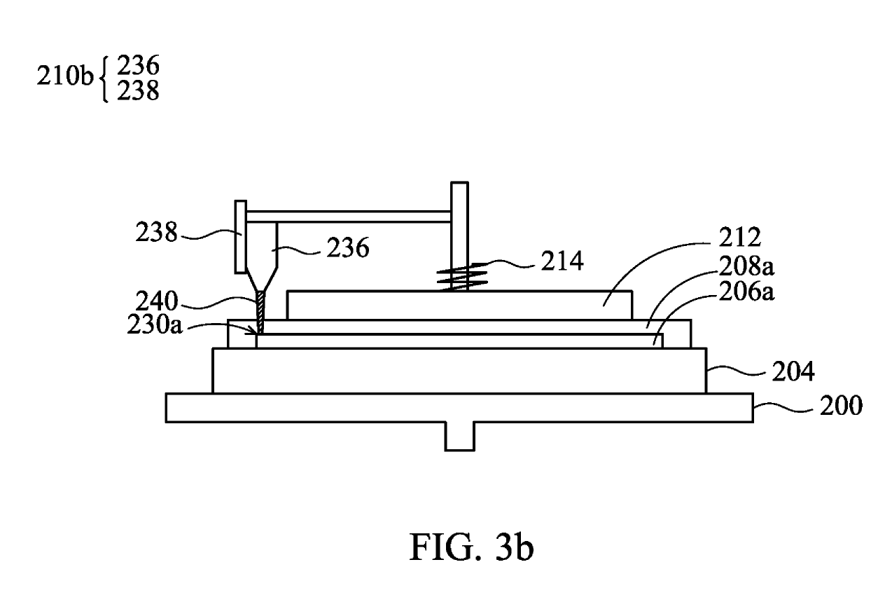

FIGS. 3a to 3b show other exemplary embodiments of apparatuses for de-bonding a flexible device, showing different separation devices. As shown in FIG. 3a, in other embodiments, a separation device 210a of the apparatus for de-bonding a flexible device may be a single I-shaped cutting knife 210a. During the separation process, the I-shaped cutting knife 210a may cut and separate the flexible device 208a along different directions through rotating the I-shaped cutting knife 210a.

As shown in FIG. 3b, in other embodiments, a separation device 210b of the apparatus for de-bonding a flexible device may be a laser beam generator 210b. The laser beam generator 210b may comprise a laser head 236 to generate a laser beam 240, thereby gasifying the release layer with air entering into the interface 230a between the flexible device 208a and the release layer 206a during the separation process. Therefore, the flexible device 208a can be separated from the release layer 206a and the carrier substrate 204. The laser beam generator 210b may further comprise a focus device 238 connected to the laser head 236. The focus device 238 is used to adjust a focus position of the laser beam 240 along a normal line of the flexible device 208a to focus on the interface 230a between the flexible device 208a and the release layer 206a, thereby performing the separation process

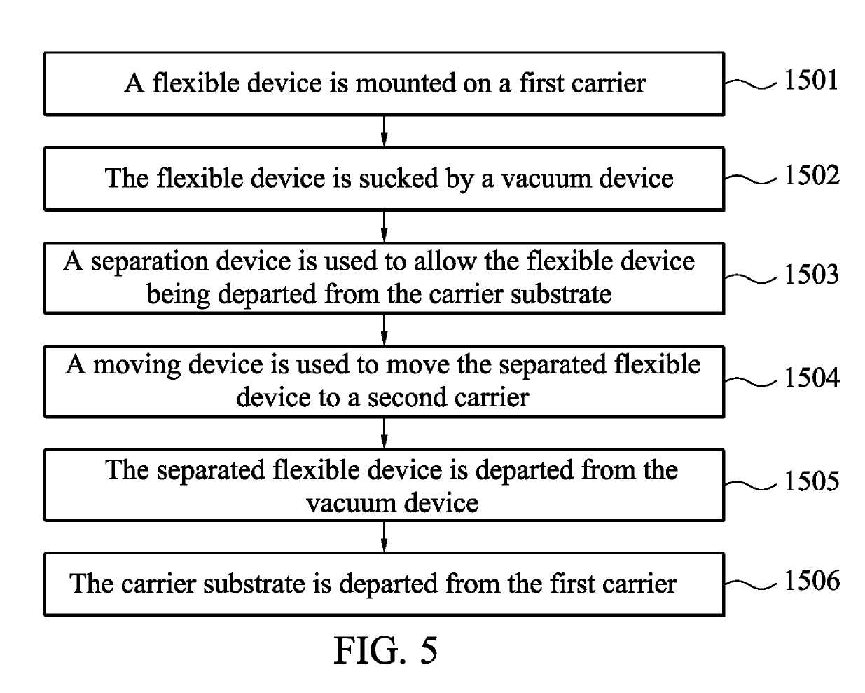

FIG. 5 is a flow diagram showing a method for de-bonding a flexible device of the invention. As shown in step 1501, a flexible device is mounted on a first carrier, wherein the flexible device is disposed over a carrier substrate, covering a de-bonding layer disposed on the carrier substrate. As shown in step 1502, next, the flexible device is suctioned by a vacuum device to prevent the separated flexible device from curving after a separation process is performed. Also, the vacuum device provides stable suction for the separated flexible device. As shown in step 1503, next, a separation device may be used to enable air to enter into an interface between the release layer and the flexible device, thereby allowing the flexible device from being separated from the carrier substrate. As shown in step 1504, next, a moving device, which is connected to the separation device and the vacuum device, may be used to move the separated flexible device suctioned by the vacuum device to a second carrier. As shown in step 1505, next, the separated flexible device is separated from the vacuum device by a process such as a vacuum release process. As shown in step 1506, finally, the carrier substrate is separated from the first carrier by a process such as a vacuum release process, an electrostatic release process or a removal process.

One exemplary embodiment of an apparatus for de-bonding a flexible device and a method for de-bonding a flexible device are applied to a flexible device having a release layer. The apparatus for de-bonding a flexible device comprises a vacuum device and a separation device to cut and suck the flexible device at the same time. The apparatus for de-bonding a flexible device and the method for de-bonding a flexible device may be applied to separation processes of flexible devices and large carriers with advantages of high throughput, stable processes, high fabrication yield and so on. Therefore, the apparatus for de-bonding a flexible device and the method for de-bonding a flexible device may be applied to fabrication processes of a flexible device. Additionally, the method for de-bonding a flexible device according to the invention may be applied to flexible device de-bonding of a release layer comprising a flexible substrate, a flexible gas and hydraulic barrier layer or a flexible electronic device such as a flexible electronic display, a flexible electronic touch panel, a flexible solar cell or a flexible electronic sensor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for de-bonding a flexible device, comprising:
a carrier used to mount a carrier substrate thereon, a release layer thereon and a flexible device covering the release layer;
a separation device disposed over the carrier to separate the flexible device from the release layer and the carrier substrate with air entering into an interface between the flexible device and the release layer; and
a vacuum device disposed over the carrier to suction the flexible device.

2. The apparatus for de-bonding a flexible device as claimed in claim 1, wherein the flexible device covers a portion of the carrier substrate.

3. The apparatus for de-bonding a flexible device as claimed in claim 1, wherein the separation device comprises a cutting knife to apply a pressure on a specific position according to the interface between the flexible device and the release layer.

4. The apparatus for de-bonding a flexible device as claimed in claim 3, wherein a hardness of the cutting knife is larger than that of the flexible device.

5. The apparatus for de-bonding a flexible device as claimed in claim 3, wherein a shape of the cutting knife is a hollow square shape or I-shaped.

6. The apparatus for de-bonding a flexible device as claimed in claim 1, wherein the separation device is a laser beam generator to generate a laser beam to gasify the release layer.

7. The apparatus for de-bonding a flexible device as claimed in claim 6, wherein the laser beam generator further comprises a focus device to adjust a focus position of the laser beam along the normal line of the flexible device.

8. The apparatus for de-bonding a flexible device as claimed in claim 1, further comprising a moving device connected to the separation device and the vacuum device, wherein the moving device is used to change a relative position and a relative height of the separation device and the vacuum device to the carrier.

9. The apparatus for de-bonding a flexible device as claimed in claim 1,
wherein the moving device comprises:
a motor; and
a control computer to control the motor.

10. The apparatus for de-bonding a flexible device as claimed in claim 1 wherein the carrier mounts the carrier substrate by vacuum suction, electrostatic suction, adhesive suction or tenon fixing.

11. The apparatus for de-bonding a flexible device as claimed in claim 1 wherein the flexible device separated from the carrier substrate is suctioned by and onto the vacuum device, and an angle between a surface of the flexible device separated from the carrier substrate and a surface of the carrier substrate is between 0 and 90 degrees.

12. The apparatus for de-bonding a flexible device as claimed in claim 1 wherein the flexible device comprises a flexible substrate, a flexible gas and hydraulic barrier layer or a flexible electronic device.

13. A method for de-bonding a flexible device, comprising:
providing a first carrier to mount a carrier substrate thereon, a release layer thereon and a flexible device covering the release layer;
performing a vacuum suction process to suction the flexible device using a vacuum device;
performing a separation process with air entering into an interface between the flexible device and the release layer to separate the flexible device from the release layer and the carrier substrate using a separation device; and
performing a first release process so that the separated flexible device is separated from the vacuum device.

14. The method for de-bonding a flexible device as claimed in claim 13, wherein the flexible substrate covers a portion of the carrier substrate.

15. The method for de-bonding a flexible device as claimed in claim 13, further comprising performing a removal process to move the separated flexible device to a second carrier using a moving device connected to the separation device and the vacuum device before performing the first release process.

16. The method for de-bonding a flexible device as claimed in claim 13, wherein the first carrier mounts the carrier substrate by vacuum suction, electrostatic suction, adhesive suction or tenon fixing.

17. The method for de-bonding a flexible device as claimed in claim 15, wherein the second carrier mounts the separated flexible device by vacuum suction, electrostatic suction, adhesive suction or tenon fixing after performing the first release process.

18. The method for de-bonding a flexible device as claimed in claim 13, further comprising performing a second release process so that the carrier substrate is separated from the first carrier.

19. The method for de-bonding a flexible device as claimed in claim 13, wherein the separation device comprises a cutting knife to apply a pressure on a specific according to the interface between the flexible device and the release layer.

20. The method for de-bonding a flexible device as claimed in claim 19, wherein a hardness of the cutting knife is larger than that of the flexible device.

21. The method for de-bonding a flexible device as claimed in claim 13, wherein a shape of the cutting knife is a hollow square shape or I-shaped.

22. The method for de-bonding a flexible device as claimed in claim 13, wherein the separation device is a laser beam generator to generate a laser beam to gasify the release layer.

23. The method for de-bonding a flexible device as claimed in claim 13, wherein the flexible device separated from the carrier substrate is suctioned by and onto the vacuum device, and an angle between a surface of the flexible device separated from the carrier substrate and a surface of the carrier substrate is between 0 and 90 degrees.
